(19) United States
(12) Patent Application Publication
(10) Pub. No.: US 2012/0185124 A1
(43) Pub. Date: Jul. 19, 2012

(54) AUTOMATED VEHICLE-WIDE DATA ACQUISITION AND ISSUE MANAGEMENT SYSTEM

(75) Inventors: William Leisenring, Tecumseh, MI (US); Naga Puttagunta, Northville, MI (US); Kenneth Raupp, Ann Arbor, MI (US); Nathan Nantais, Windsor (CA); Marc Ford, Clarkston, MI (US)

(73) Assignee: CONTROL-TEC, LLC, Allen Park, MI (US)

(21) Appl. No.: 13/352,042

(22) Filed: Jan. 17, 2012

Related U.S. Application Data
(63) Continuation-in-part of application No. 13/134,660, filed on Jun. 14, 2011.
(60) Provisional application No. 61/461,538, filed on Jan. 18, 2011.
(60) Provisional application No. 61/513,947, filed on Aug. 1, 2011.

(51) Int. Cl. G06F 7/00

(52) U.S. Cl. 701/31.4; 701/1; 701/33.4

(57) ABSTRACT

Disclosed is an automated data acquisition and issue management system which includes a server, and code which is readable by an electronic control unit data recorder. The electronic control unit data recorder is configured to receive data from at least one electronic control unit. The code is configured to provide that the electronic control unit data recorder receives data from at least one electronic control unit, collects, processes, and transmits the data to the server. The code is also preferably configured to provide that the electronic control unit data recorder identifies at least one issue with regard at least one electronic control unit and communicates data regarding said issue to the server.

### RELATED APPLICATIONS (PRIORITY CLAIM)

This application claims the benefit of U.S. Provisional Application Ser. No. 61/461,538, filed Jan. 18, 2011, claims the benefit of U.S. Provisional Application Ser. No. 61/513,947, filed Aug. 1, 2011, and is a continuation-in-part of U.S. patent application Ser. No. 13/134,660, filed Jun. 14, 2011, all of which are hereby incorporated herein by reference in their entirety.

### REFERENCE TO COMPACT DISCS (CD-R'S) FILED WITH PARENT APPLICATION

Duplicate compact discs (CD-R's) were filed with parent application Ser. No. 13/134,660 as a computer program listing appendix. Each compact disc contains the following files: “seldloggerCode” (24 KB, created Jan. 14, 2011) and “uploadDataCode” (50 KB, created Jan. 14, 2011). The material on the compact discs is incorporated herein by reference.

### COPYRIGHT NOTICE

A portion of the disclosure of this patent application (including the files contained on the compact discs) contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### BACKGROUND

The present invention generally relates to electronic control unit data recorders, such as vehicle data recorders.

A vehicle data recorder is a recording device which is present in a vehicle and which receives information from various electronic control units which are present in the vehicle. Each of the electronic control units controls one or more of the electrical systems or subsystems in the vehicle. Examples of some of the electronic control units which may be present in a vehicle include, but are not limited to, an airbag control unit, an engine control unit, a seat control unit, a speed control unit, and a transmission control unit. The vehicle data recorder receives information from the various electronic control units, and stores the information in memory and/or transmits the information wirelessly to a remote location. This information can be used for various purposes, for example to assess the function and performance of a pre-production or post-production vehicle, or to manage a fleet of vehicles.

A typical vehicle data recorder that is sufficiently intelligent to receive proprietary information from a vehicle is configured to only work with a specific vehicle configuration, such as a specific make and model of vehicle which has a certain engine and transmission, certain emission systems, as well as certain electronic control unit hardware/software configurations. Specifically, the vehicle data recorder has a configuration stored therein which dictates how the vehicle data recorder collects and processes data received from the electronic control units. The configuration which is stored in the vehicle data recorder is vehicle-specific. Therefore, to manage a fleet of vehicles, where the fleet includes vehicles of various configurations such as various makes and models of vehicles, one must employ a plurality of different vehicle data recorders.

### SUMMARY

The present invention is directed at providing an automated data acquisition and issue management system which comprises a server, and code which is readable by an electronic control unit data recorder. The electronic control unit data recorder is configured to receive data from at least one electronic control unit. The code is configured to provide that the electronic control unit data recorder receives data from at least one electronic control unit, collects, processes, and transmits the data to the server. The code is also preferably configured to provide that the electronic control unit data recorder identifies at least one issue with regard at least one electronic control unit and communicates data regarding said issue to the server

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a block diagram of a fleet management system which employs a plurality of electronic control unit data recorders, each of which is in accordance with an embodiment of the present invention;

FIG. 2 provides a high level diagram of each of the electronic control unit data recorders shown in FIG. 1;

FIGS. 3-5 provide flowcharts regarding the automated configuration deployment, management, selection, error-handling and configuring of each of the electronic control unit data recorders shown in FIG. 1; and

FIG. 6 provides two screen shots relating to a user interface of a web-based issue management system which is in accordance with an embodiment of the present invention.

### DETAILED DESCRIPTION OF AN ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

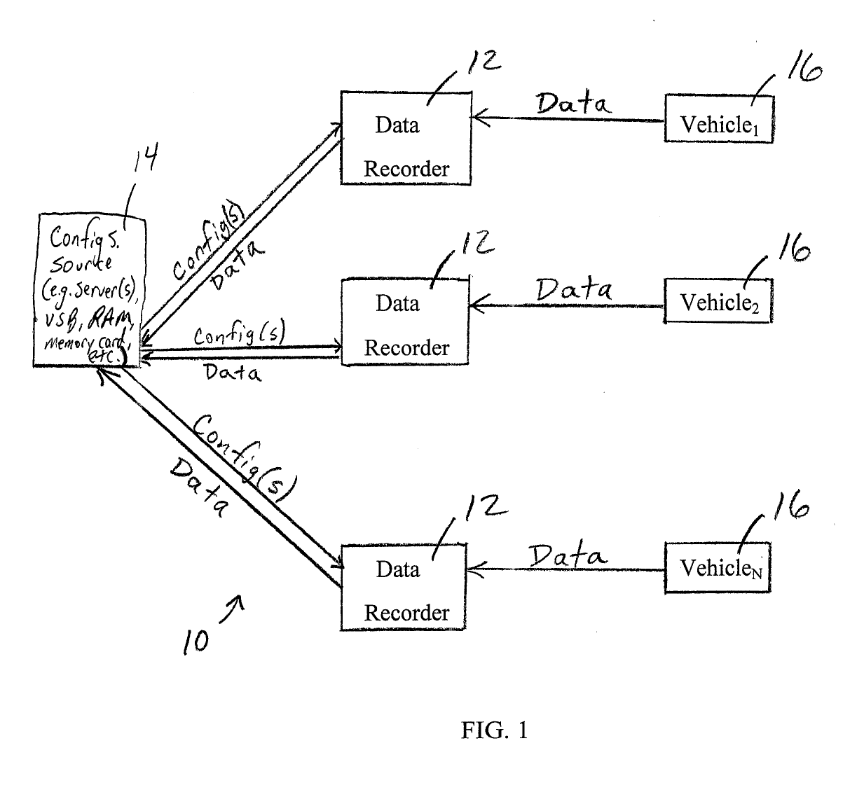

FIG. 1 illustrates a fleet management system 10 which employs a plurality of electronic control unit data recorders 12, wherein each of the electronic control unit data recorders 12 is identical and contains code which is in accordance with an embodiment of the present invention. Specifically, each of the electronic control unit data recorders 12 contains code in its memory which provides, as shown in FIG. 1, that the electronic control unit data recorder 12 receives a plurality of configurations from one or more servers 14 and stores the configurations in memory. Each of the configurations which is received and stored in the memory of the electronic control unit data recorder 12 relates to, for example, a different vehicle configuration, wherein the configuration is specific with regard to several factors, such as the make of the vehicle, the exact level of model year, as well as the exact engine, transmission, emission systems, and electronic control unit hardware/software, etc. embodied in the vehicle.

The code stored in the memory of the electronic control unit data recorder 12 provides that thereafter the electronic control unit data recorder 12 can be interfaced with a vehicle 16 (in FIG. 1, the vehicles 16 are identified with “Vehicle₁”, “Vehicle₂”, . . . “Vehicle_{N}”, thereby indicating that each of the vehicles can be of a different configuration (i.e., a different configuration with regard to the make of the vehicle, the exact level of model year, as well as the exact engine, transmission, emission systems, and electronic control unit hardware/software, etc. embodied in the vehicle)), and the electronic control unit data recorder 12 receives information from the vehicle 16 which allows the electronic control unit data recorder 12 to identify the exact configuration of the vehicle 16. Based on the identification, the electronic control unit data recorder 12 effectively selects one of the configurations stored in memory to use in connection with data collection and processing vis-à-vis the electronic control units of the vehicle 16. The electronic control unit data recorder 12 may also store in memory a default configuration which can be used whenever the electronic control unit data recorder 12 is unable to identify the exact configuration of a given vehicle.

Alternatively, the code stored in the memory of the electronic control unit data recorder 12 can be configured such that the electronic control unit data recorder 12 receives information from the vehicle 16 which allows the electronic control unit data recorder 12 to identify the exact configuration of the vehicle 16 and then based on the identification, the electronic control unit data recorder 12 retrieves the correct configuration from the one or more servers 14 and stores the configuration in memory for subsequent use in connection with data collection and processing vis-à-vis the electronic control units of the vehicle 16.

Still further, instead of having to obtain one or more configurations from a remote location such as from one or more servers 14, a plurality of configurations may be pre-stored in the memory of the electronic control unit data recorder 12. As such, as shown in FIG. 1, reference numeral 14 can refer to any appropriate source for the configurations, such as one or more remote servers, a USB port on the electronic control unit data recorder 12, RAM of the electronic control unit data recorder 12, a memory card (such as an SD card) of the electronic control unit data recorder 12, etc. Regardless, preferably thereafter the electronic control unit data recorder 12 receives information from the vehicle 16 which allows the electronic control unit data recorder 12 to identify the exact configuration of the vehicle 16. Based on the identification, the electronic control unit data recorder 12 subsequently uses the correct configuration in connection with data collection and processing vis-à-vis the electronic control units of the vehicle 16.

Regardless, the code stored in the memory of the electronic control unit data recorder 12 provides that once the electronic control unit data recorder 12 selects a configuration, the electronic control unit data recorder 12 thereafter collects data from various electronic control units and processes the data pursuant to the configuration. The configuration also dictates what data is stored by the electronic control unit data recorder 12, as well as also possibly what data is transmitted by the electronic control unit data recorder 12 to a remote location.

Preferably, the code stored in the memory of the electronic control unit data recorder 12 provides that the electronic control unit data recorder can communicate with the server(s) 14 and dynamically update at least one of its stored configurations, thereby providing an electronic control unit data recorder 12 having a dynamic configuration.

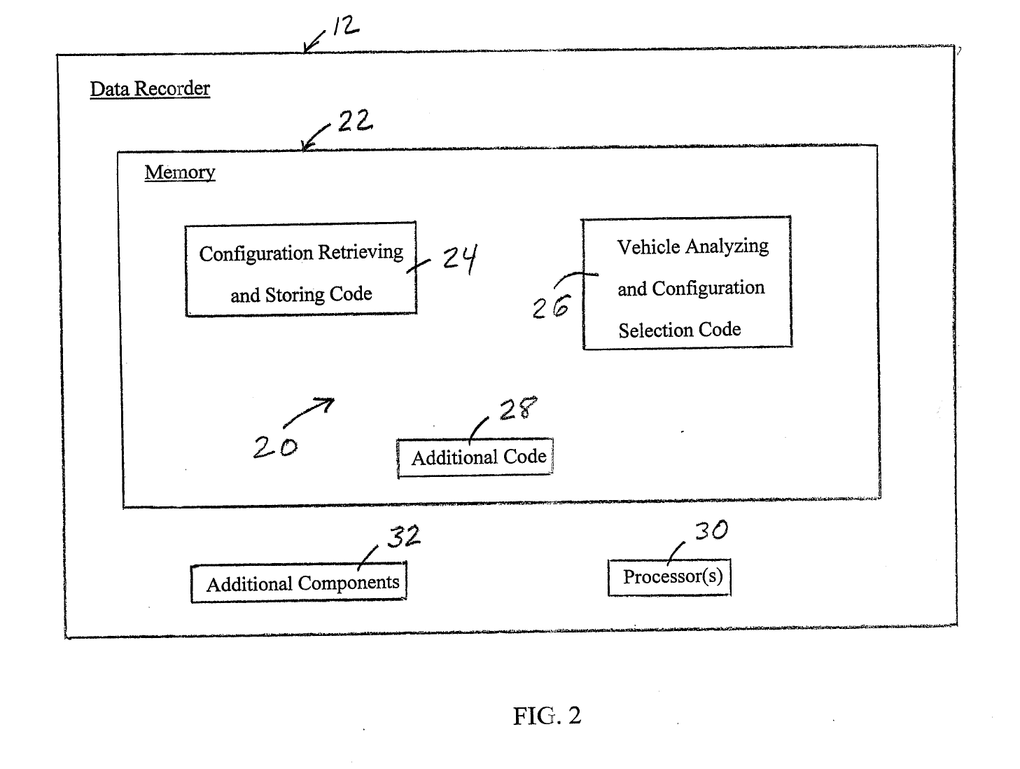

FIG. 2 provides a high level diagram of the electronic control unit data recorder 12, including the code 20 which is stored in the memory 22 of the electronic control unit data recorder 12, wherein the code is in accordance with a preferred embodiment of the present invention with other embodiments being entirely possible. As shown, a preferred embodiment of the present invention provides that the code 20 which is stored in memory 22 preferably includes configuration retrieving and storing code 24, which provides that the electronic control unit data recorder 12 receives a plurality of configurations from one or more servers 14 (see FIG. 1) and stores the configurations in memory 22. As shown, the code 20 which is stored in memory 22 also preferably includes vehicle analyzing and configuration selection code 26, which provides that the electronic control unit data recorder 12 receives information from a vehicle 16 (see FIG. 1) which allows the electronic control unit data recorder 12 to identify the exact configuration of the vehicle 16. Thereafter, based on the identification, the electronic control unit data recorder 12 effectively selects one of the configurations stored in memory 22 to use in connection with data collection and processing vis-à-vis the electronic control units of the vehicle 16. As shown, the code which is stored in memory also preferably includes additional code 28, including data acquisition and data transmission code, which additionally dictates and controls the operation and functionality of the electronic control unit data recorder 12. As shown in FIG. 2, in addition to the memory 22 and code 20 stored therein, the electronic control unit data recorder 12 also includes one or more processors 30 as well as additional components 32 which are relevant to the operation and functionality of the electronic control unit data recorder 12.

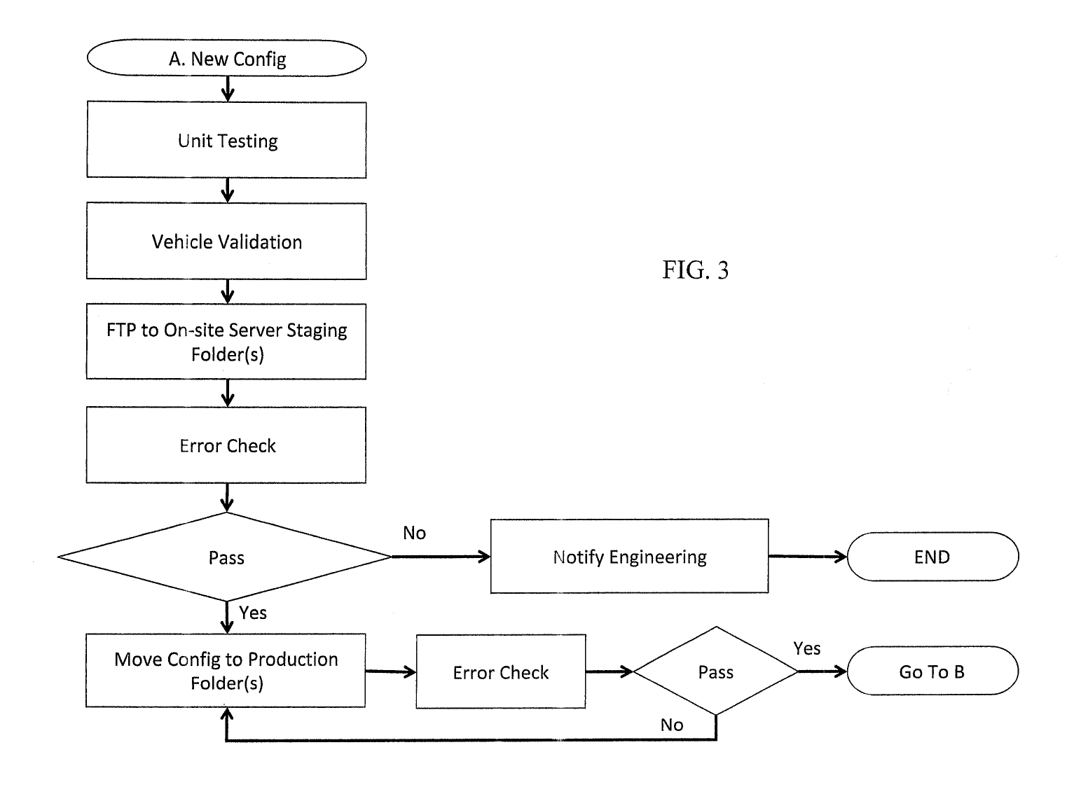

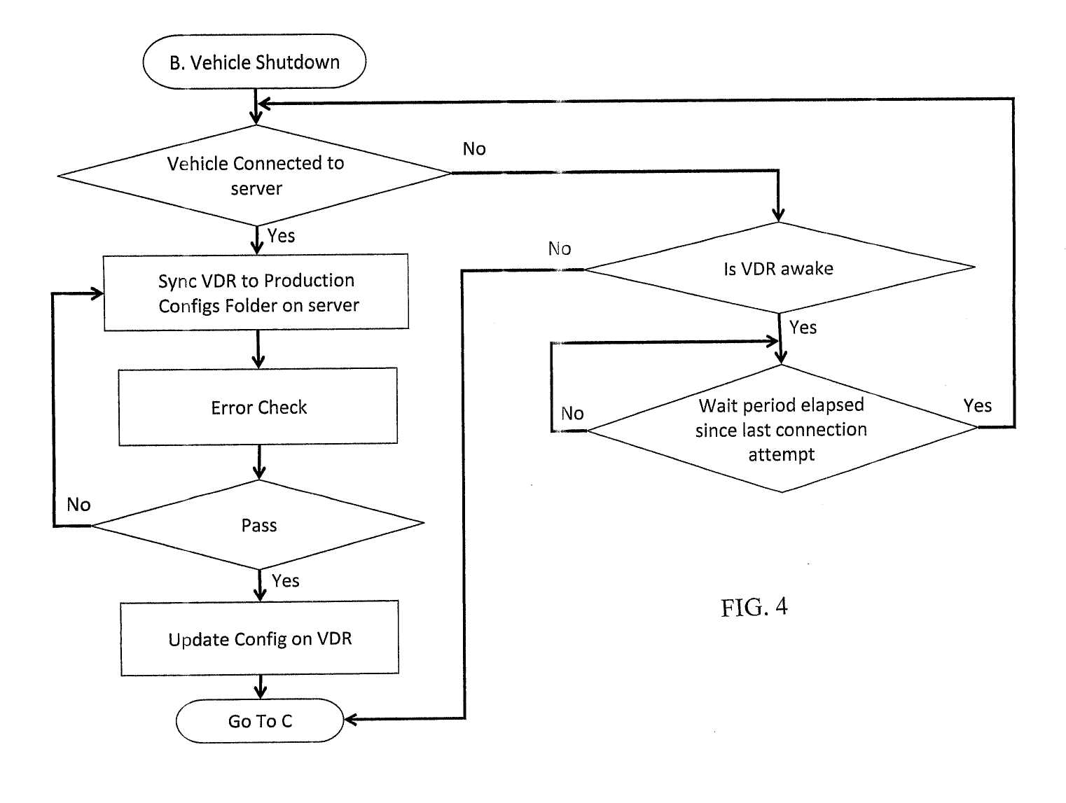

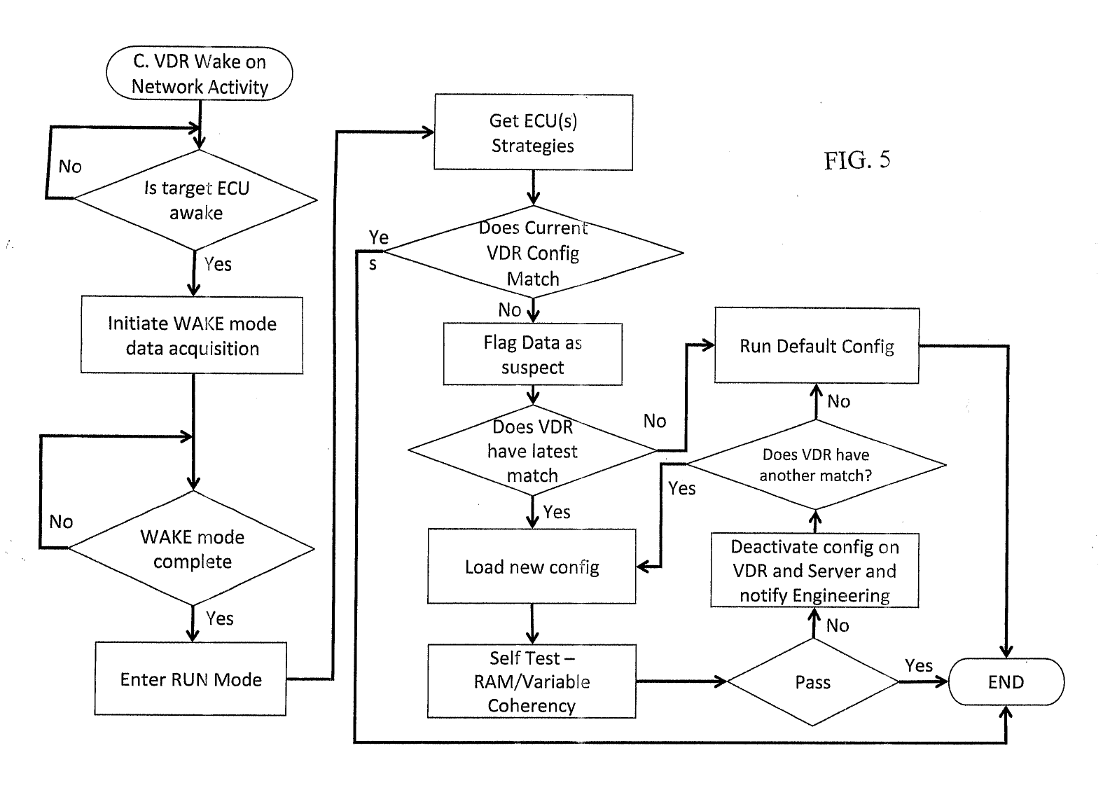

FIGS. 3-5 provide flowcharts regarding the automated configuration deployment, management, selection, error-handling and configuring of the electronic control unit data recorder 12 (and each of the electronic control unit data recorders 12 shown in FIG. 1), and are self-explanatory.

The code which is included on the compact discs which have been deposited with the United States Patent and Trademark Office and filed with parent application Ser. No. 13/134,660 corresponds to the configuration retrieving and storing code 24 and configuration selection code 26 which has been described hereinabove.

Preferably, the code 20 of each electronic control unit data recorder 12 provides that each electronic control unit data recorder 12 is configured to identify certain issues with regard to the corresponding vehicle 16 in real time, and then acquire data (such as a diagnostic trouble code or “DTC”) from the vehicle 16. Preferably, the code 20 of the electronic control unit data recorder 12 is configured such that this data gets transferred substantially immediately to the server 14 for further processing.

Preferably, the server 14 is configured to issue an electronic alert to a customer (such as via an SMS message or email, for example) thereby alerting the customer of the issue relating to the vehicle 16. Preferably, the server 14 is configured to provide a web-based issue management system with data analysis and issue management features. This approach effectively combines data acquisition, telematics, issue resolution, data analysis, and issue management in a single system (item 10 in FIG. 1). This leads to significant reductions in root cause time which improves quality. While this approach has been described with regard to a fleet management system, it is employable and useful with regard to any product validation or engineering process.

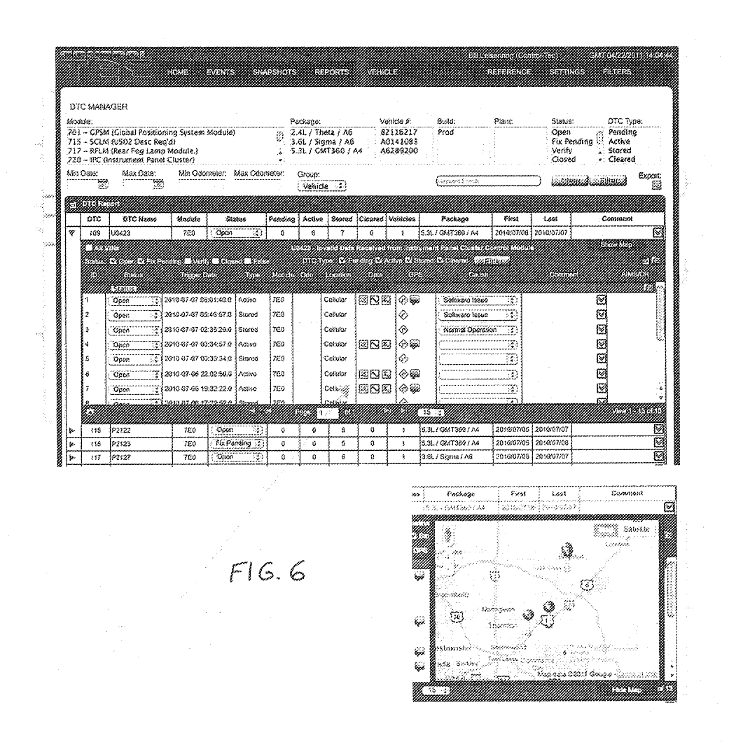

With regard to the web-based issue management system described above, FIG. 6 illustrates one possible user interface. Specifically, FIG. 6 provides two screen shots which illustrate some of the preferred and useful features, and are self-explanatory. Preferably, the system provides filters relating to the issues which have been identified, provides for the ability to export reports and summaries regarding the issues which have been identified such is in .pdf format, lists each occurrence of an issue on screen, allows for the ability to access and analyze data at the time of issue occurrence and detection, and identifies the location of all occurrences such as on a map.

While the present disclosure specifically discusses a vehicle data recorder as being the type of electronic control unit data recorder with which the present invention is utilized, the present invention can be implemented in many other types of devices and systems. For example, the present invention can be used to manage a fleet of boats, a plurality of bridges, or really anything which is capable of being monitored and/or controlled by one or more electronic control units.

With regard to employing the present invention with regard to a vehicle fleet management system 10 as shown in FIG. 1, preferably each vehicle 16 is equipped with an electronic control unit data recorder 12 as described above, and the electronic control unit data recorder 12 is configured (via the code 20) to continuously monitor for DTC's on all electronic control units of the vehicle 16 and the list of DTC's and their status is stored in memory 22 of the electronic control unit data recorder 12. Every new DTC list is compared with the previously sampled list. Any changes to the list are identified and data is then written accordingly and saved in the memory 22. This data is then transferred automatically (such as via cellular or WiFi) to a central processing and storage server 14. Based on the data and if any customer(s) are subscribed to the issue alerts, notifications such as SMS messages or email(s) will automatically be sent alerting the customer(s) of the occurrence of the DTC. The data is then accessible via a web front end (such as is illustrated in FIG. 6). The web-based software provides data analysis to aid in root cause analysis of the issue, and automated issue management which categorizes all like occurrences into one issue and provides the capability to change issue states (i.e., Open, Fix Pending, Verify, Closed or False), comment tracking, as well as assigning the issue to someone for lead responsibility in the root cause process of the issue. Preferably, the system automatically emails the assignee an issue summary when they are assigned the issue as well.

As discussed above, preferably the electronic control unit data recorder 12 is configured (via the code 20) to continuously monitor for DTC's on all electronic control units of the vehicle 16 and the list of DTC's and their status is stored in memory 22 of the electronic control unit data recorder 12. Preferably, the code 20 is configured such that the electronic control unit data recorder 12 resets the list upon being disconnected from one vehicle and being connected to another vehicle. Additionally, preferably the code 20 is configured such that the electronic control unit data recorder 12 polls each electronic control unit independently with regard to frequency, and records different data depending on issues identified by the electronic control unit data recorder 12.

While the above description has focused primarily of DTR's, the electronic control unit data recorder 12 can be configured (via the code 20) to detect other event triggers as a function of the electronic control unit data and logic of the configuration of the electronic control unit data recorder 12.

While a specific embodiment of the present invention is shown and described, it is envisioned that those skilled in the art may devise various modifications without departing from the spirit and scope of the present invention.

What is claimed is:

1. An automated data acquisition and issue management system comprising: a server; and code which is readable by an electronic control unit data recorder, wherein the electronic control unit data recorder is configured to receive data from at least one electronic control unit, wherein the code is configured to provide that the electronic control unit data recorder receives data from at least one electronic control unit, collects, processes, and transmits the data to the server, wherein the code is configured to provide that the electronic control unit data recorder identifies at least one issue with regard at least one electronic control unit and communicates data regarding said issue to the server.

2. An automated data acquisition and issue management system as recited in claim 1, wherein the server provides a web-based issue management system comprising data analysis and issue management.

3. An automated data acquisition and issue management system as recited in claim 2, wherein the server is configured to issue an alert upon receipt of data relating to an issue detected with regard to at least one electronic control unit.

4. An automated data acquisition and issue management system as recited in claim 2, wherein the web-based issue management system is configured to provide a user interface which displays each occurrence of issues detected by at least one electronic control unit data recorder.

5. An automated data acquisition and issue management system as recited in claim 2, wherein the electronic control unit data recorder is configured to compile a list of diagnostic trouble codes and store the list in memory.

6. An automated data acquisition and issue management system as recited in claim 5, wherein the electronic control unit data recorder is configured to identify any changes to the list, and as a result of said changes being identified, transmit data to the server.

7. An automated data acquisition and issue management system as recited in claim 6, wherein the system is configured to provide that the data which has been transmitted by the electronic control unit data recorder to the server is accessible on the Internet.

8. An automated data acquisition and issue management system as recited in claim 7, wherein the system is configured to map a location of an issue which has been identified.

9. An automated data acquisition and issue management system as recited in claim 5, wherein the code is configured such that the electronic control unit data recorder resets the list upon being disconnected from one vehicle and being connected to another vehicle.

10. An automated data acquisition and issue management system as recited in claim 1, wherein the code is configured such the electronic control unit data recorder polls each electronic control unit independently with regard to frequency.

11. An automated data acquisition and issue management system as recited in claim 1, wherein the code is configured such the electronic control unit data recorder records different data depending on issues identified by the electronic control unit data recorder.

12. An automated data acquisition and issue management system as recited in claim 1, wherein code of the electronic control unit data recorder is configured such that the electronic control unit data recorder detects event triggers as a function of electronic control unit data collected and logic of a configuration of the electronic control unit data recorder.
